(19) United States
(12) Patent Application Publication
(10) Pub. No.: US 2009/0200233 A1
(43) Pub. Date: Aug. 13, 2009

(54) METHODS AND DEVICES FOR THE REMOVAL OF ORGANIC CONTAMINANTS FROM WATER

(75) Inventors: John A. Bergendahl, Worcester, MA (US); Natalya Koryabkina, Worcester, MA (US)

Correspondence Address: BURNS & LEVINSON, LLP, 125 SUMMER STREET, BOSTON, MA, 02110, US

(73) Assignee: Worcester Polytechnic Institute, Worcester, MA (US)

(21) Appl. No.: 12/093,055

(22) PCT Filed: Nov. 7, 2006
(86) PCT No.: PCT/US06/60591

§ 371 Date: Oct. 3, 2008

Related U.S. Application Data
(60) Provisional application No. 60/734,567, filed on Nov. 8, 2005.

(51) Int. Cl. C02F 1/28; B01J 20/02; B01D 65/02; B01D 15/00

(52) U.S. Cl. 210/636; 210/673

(57) ABSTRACT

Compositions, methods and devices for the removal of organic contaminants from fluids using hydrophobic micro-porous adsorbents, which are regenerated by advanced oxidation.

### RELATED APPLICATIONS

This applications claims priority to and the benefit of U.S. Provisional Application Ser. No. 60/734,567, filed Nov. 8, 2005.

### STATEMENT REGARDING FEDERALLY SPONSORED RESEARCH

This invention was made partially with U.S. Government support from the National Institutes of Health under SBIR Phase I grant, no. 1 R43 ES0 12784-01 awarded to Triton Systems. The U.S. Government has certain rights in the invention.

### BACKGROUND OF THE INVENTION

Many water sources are impacted by organic contaminants rendering those sources unfit for supplying water for use. Many effluents from industry or municipal wastewater treatment systems contain organic contaminants that must be removed before discharging or reusing the water. Organic contaminants of concern include: chloroform, trichloroacetic acid, trichloroethylene, methyl tent butyl ether, and numerous others.

Chlorination is the most common method used to kill waterborne pathogens in drinking water and wastewater. Unfortunately, unwanted side reactions can occur between chlorine and various organic compounds in the water that may lead to the generation of a large number of halogenated organic molecules, collectively known as disinfection byproducts (“DBP”), Many of these DBPs are usually present at low concentrations, but are considered carcinogenic, genotoxic and/or mutagenic. Exposure to low levels of DBPs over long periods of time through the use of chlorinated water for drinking, washing, and cooking is believed to be deleterious to human health.

A typical treatment technology for removing organic contaminants from water, activated carbon, is subject to the problems of low capacity, fouling from natural organic matter (“NOM”), and the costs of high temperature regeneration or costly disposal. NOM consisting of relatively large, high molecular weight compounds found in natural water supplies are known to block the large pores of activated carbon, thereby reducing the carbon's efficacy for contaminant removal. In lieu of treatment with activated carbon, advanced oxidation may mineralize organic contaminants in water. However, using advanced oxidation technologies on the water directly requires extremely large processing equipment to reduce contamination concentration to the low levels required by drinking water standards or discharge standards.

Hydrophobic molecular sieves avoid these disadvantages since their smaller pores exclude NOM, thereby increasing the selective capacity for organic contaminant removal. Thermal volatilization or burial of saturated adsorbents as is currently done results in the transfer of the hazardous materials from the adsorbent phase. This strategy simply postpones dealing with the hazardous materials.

In contrast, the present invention is directed toward using advanced oxidation processes to mineralize the organics captured inside adsorbent pores of hydrophobic molecular sieves thus regenerating the sieves. Some of the advantages of these methods include much smaller processing volumes, the drinking water is never in contact with the advanced oxidation reagents, the organics are mineralized to safer end-products (carbon dioxide and water), reduce oxidant demand, and the hydrophobic molecular sieves can be reused repeatedly.

### SUMMARY OF THE INVENTION

The present invention is directed to compositions and methods for the removal of organic contaminants from water. In one aspect, this removal is accomplished by using hydrophobic microporous adsorbents followed by advanced oxidation to remove bound contaminants from the adsorbents. Coupling these two processes, concentration and removal by adsorption followed by advanced oxidation, provides for effective removal of organic contaminants from water, and ultimate destruction of the contaminants.

In one embodiment, the present invention is directed to methods for the removal of organic contaminants from water. In one aspect, the invention involves contacting water with a hydrophobic adsorbent, separating or removing the adsorbent from the water, followed by reacting any adsorbed material from the adsorbent with an advanced oxidation reagent.

In one aspect, the hydrophobic adsorbents are hydrophobic molecular sieves. In some aspects, the hydrophobic molecular sieves are zeolites. Particular examples include, but are not limited to, silicalite-1, dealuminated zeolite Y, ZSM-5, mordenite, and zeolite beta. Other sieves of the invention include larger pore Mobil Composition of Matter (“MCM”) materials or activated carbons.

In one aspect, hydroxyl radicals are employed for advanced oxidation and are generated by advanced oxidation reagents, such as ozone, ozone/hydrogen peroxide, ferrous iron/hydrogen peroxide, zerovalent iron/hydrogen peroxide and others. Alternatively, the hydroxyl radicals used for advanced oxidation are generated by various electrochemical processes or by exposure to ultraviolet light/hydrogen peroxide or ultraviolet light/titania.

In one aspect, the water contaminants are organics including disinfection byproducts (DBPs), volatile organics, endocrine disruptors, gasoline constituents, pharmaceuticals, pesticides, and others.

### BRIEF DESCRIPTION OF THE DRAWINGS

FIG. 1 is a graph showing the removal of TCE from water using zeolites and activated carbon;

FIG. 2 is a graph showing the removal of MTBE from water using zeolites and activated carbon;

FIG. 3 is a graph showing the degradation of MTBE with Fe⁰/H₂O₂ advanced oxidation;

FIG. 4 is a graph of chloroform (“CLF”) and trichloroacetic acid (“TCAA”) adsorption isotherms on silicalite-1 and dealuminated Y zeolite (“DAY”);

FIG. 5 is a graph of the kinetics of CLF adsorption to silicalite-1 (duplicate runs);

FIG. 6 is a graph showing the effect of humic acid on CLF adsorption on silicalite-1;

FIG. 7A is a graph showing the effect of Fe coating (25% by weight) on adsorption of CLF on zeolites;

FIG. 7B is a graph showing the effect of Fe coating (25% by weight) on adsorption of TCAA on zeolites;

FIG. 8 is a bar graph of the regeneration of silicalite-1 and DAY with Fe⁰/H₂O₂ advanced oxidation after CLF contact;

FIG. 9 is a bar graph of the regeneration of Fe0-coated silicalite-1 with Fe⁰/H₂O₂ advanced oxidation after CLF contact;

FIG. 10 is a bar graph of aqueous iron (Fe) concentration after adsorption of CLF and oxidation cycles; and

FIG. 11 is a bar graph of aqueous iron (Fe) concentration after one TCAA adsorption cycle for various initial TCAA concentrations.

### DETAILED DESCRIPTION OF THE INVENTION

The present invention is directed to methods for the removal of organic contaminants from water. In particular, this removal process utilizes hydrophobic microporous adsorbents followed by advanced oxidation reactions to remove bound contaminants from the adsorbents. Coupling these two processes, concentration and removal by adsorption followed by advanced oxidation, provides for effective removal of organic contaminants from water, and ultimate destruction of the contaminants.

Organic contaminants in water must be removed prior to human consumption and other uses. A common process for this application, activated carbon adsorption, is subject to the problems of low capacity, competition from natural organic matter (“NOM”), and the costs of high temperature regeneration or costly disposal. NOM consisting of relatively large, high molecular weight compounds found in natural water supplies are known to block the large pores of activated carbon, thereby reducing the carbon's efficacy for contaminant removal. A NOM coating can also serve as a substrate for biological growth. Using advanced oxidation technologies on the water directly requires extremely large processing equipment to reduce contamination concentration to the low levels required by drinking water standards or discharge standards.

Hydrophobic molecular sieves avoid these disadvantages since their smaller pores exclude NOM, thereby increasing the selective capacity for organics removal. Thermal volatilization or burial of saturated adsorbents as is currently done may result in the ultimate transfer of the hazardous materials from the adsorbent phase. This strategy simply postpones dealing with the hazardous materials.

In contrast, the present invention involves employing a coupled process involving molecular sieving and advanced oxidation processes. Some of the advantages of the present invention include advanced oxidation with much smaller processing volumes, the drinking water is never in contact with the advanced oxidation reagents, the organics are mineralized to safer end-products (carbon dioxide and water), reduced oxidant usage, and the hydrophobic molecular sieves can be roused repeatedly.

Advanced oxidation is the destruction of organic compounds by hydroxyl radicals. Hydroxyl radicals are highly reactive species that are formed from various electrochemical processes or various reactants including Fenton's reagent (ferrous iron and H₂O₂), H₂O₂/ultraviolet light, titania/ultraviolet light, zerovalent iron/H₂O₂, ozone, ozone/H₂O₂ and others. Advanced oxidation has almost exclusively been utilized in homogeneous aqueous solutions to destroy organics. Fenton's oxidation has been used to regenerate granular activated carbon after adsorption of chlorobenzene, tetrachloroethylene, chloroform, and 1,2-dichloropropane. Fe can be incorporated into the lattice structure of ZSM-5, and H₂O₂ decomposition and CO₂ production can be detected during C₂H₅OH oxidation.

Typically, water contaminants are organics including disinfection byproducts (DBPs), volatile organics such as trichloroethylene, methyl-tert-butyl ether, BTEX (benzene, toluene, ethylbenzene, and xylenes), alcohols, and others. In a particular aspect DBPs that can be formed during chlorination, of water include the trihalomethanes (e.g., chloroform, bromodichloromethane, and chlorodibromomethane), the haloacids (e.g., monochloroacetic acid, dichloro acetic acid, and trichloroacetic acid), halodiacids (e.g., 2,2-dichlorobutanedioic acid and 2,3-dichlorobutanedioic acid), halohydroxy-acids (e.g., 2-chloro-4-hydroxybutanoic acid and 3,3,3-trichloro-2-hydroxypropanoic), and haloketones (e.g., chloropropanone and 1,1,1-trichloropropanone). The trihalomethanes and haloacetic acids are expected to be produced in the greatest amounts during drinking water chlorination. Sec, Cohn et al. “Health and Aesthetic Aspects of Water Quality”, Water Quality and Treatment, R. D. Letterman, New York, McGraw-Hill (1999), the entire teaching of which is incorporated herein by reference.

The compositions and methods of the present invention include the application of hydrophobic microporous adsorbents. An example of such an adsorbent is a molecular sieve. Zeolites are molecular sieves that can be used in the present invention. Molecular sieve zeolites are nano-porous, crystalline solids with well-defined structures. Generally they contain silicon, aluminium and oxygen in their framework and cations, water and/or other molecules within their pores Many occur naturally as minerals, while others are synthetic, and are made commercially for specific uses. Natural zeolites are composed of hydrous aluminum silicates of sodium, calcium, potassium or barium. The framework structure contains linked cages, cavities or channels. The limiting pore sizes range from about 3-10 Å in diameter. (Further details regarding zeolites can be found in the literature. See, e.g., Szostak, R., Molecular Sieves: Principles of Synthesis and Identification. London, Blackie Academic and Professional, 2nd (1998); Baerlocher, C. and McCusker, L. B. “Database of Zeolite Structures, International Zeolite Association”, Structure Commission at website www.iza-structure.org/databases/(2005), the entire teachings of which are incorporated herein by reference.)

Zeolites are known to have an affinity for various organics, effectively removing them from water. Using silicalite, trichloroethylene (“TCE”), chloroform, tetrachloroethylene and carbon tetrachloride are favorably removed from water. Similarly, silicalite removes methyl tertiary-butyl ether (“MTBE”) from water more effectively than an activated carbon. Similar results can be obtained with trichloroacetic acid. Some zeolites are capable of ion-exchange wherein cations that compensate for an anionic charge are associated with alumina in a crystal lattice. Most cations are exchangeable, which provides ion exchange capacity to remove Ca²⁺ and Mg²⁺ from “hard” water. Such zeolites are added to laundry detergents to “soften” the water, resulting in a more effective detergent. Exchanging cations for protons contributes acidity to the AlO₄⁻ sites, making some zeolites effective catalysts. They are used as catalysts in the petroleum refining and specialty petrochemicals industries. Zeolites with a high silica content (i.e., a high Si/Al ratio) have a low ion exchange capacity, but are hydrophobic and organophilic.

Hydrophobic molecular sieve zeolites of the present invention include, but are not limited to, silicalite-1, the all-silica end member of the MFI (or ZSM-5) structure, and a dealuminated zeolite Y (DAY) having the Faujasite (FAU) structure. Silicalite-1 has a pore volume of approximately 0.19 cm³/gm with approximate pore diameters in the 5.1-5.6 Å range. The zeolite DAY, by contrast, has a pore volume of around 0.3 g cm³/gm with pore openings of about 7.4 Å. Their pore dimensions and the inherent hydrophobic surface properties make these zeolites suitable for organics removal from water.

The methods and devices of the present invention can be designed as sequential removal/regeneration systems, or continuous flow systems, or simultaneous removal/treatment systems using a single-step process. The actual designs can include fixed bed adsorbers of granular (pelletized) zeolite wherein the adsorption and oxidation takes place in the fixed bed, or sorption to zeolite powders wherein the zeolite powder is recovered from the water after adsorption has taken place, the zeolite-bound contaminant oxidized, and the zeolite then contacted with contaminated water again.

In one aspect, the adsorbents are removed or isolated from the water by centrifugation. Alternatively, the adsorbents are removed by filtration.

Another embodiment of the invention includes immobilized molecular sieve zeolites. The molecular sieve zeolites can be immobilized in various geometries, including, but not limited to, in pellets using a binder, on impermeable supports, as membranes, monolith surfaces, and as polycrystalline particulate aggregates. It could also include the formation of the zeolite into solid shapes (plates, tubes, membranes, and others). In a particular aspect, water is passed over or through immobilized or stationary hydrophobic adsorbents to concentrate and remove organic contaminants.

In one aspect, water can contact a molecular sieve (e.g., zeolite) using batch process.

The methods and devices of the invention have various applications, including different scales of systems. For example, this technology could be deployed in: developing countries, individual homes, municipal or industrial water treatment systems, camping trips, and water supply systems.

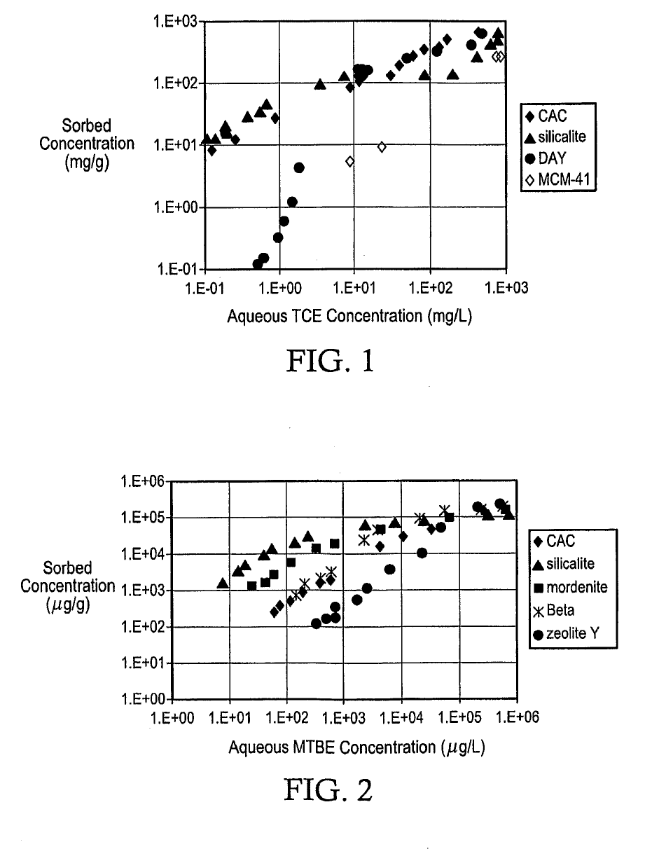

FIGS. 1 and 2 show the capacity of various zeolites to remove TCE and MTBE, respectively. Both compounds are frequently-found contaminants in U.S. waters, and both may be carcinogens or have other deleterious properties. The hydrophobic molecular sieve zeolite, silicalite, performed as well or better than the activated carbon. Similar results have been obtained for several other hazardous materials.

Advanced oxidation with Fe⁰/H₂O₂ proceeds with the following principal reactions:

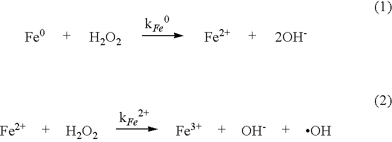

The Fe⁰ is oxidized by reaction with H₂O₂ into Fe²⁺, which in the presence of H₂O₂ is Fenton's reagent. From these reactions, hydroxyl radicals are formed, which mineralize the organics present.

The present invention is directed to methods employing a coupled process involving adsorption to molecular sieves and advanced oxidation processes. The application of advanced oxidation is the destruction of organic compounds through the use of hydroxyl radicals, very strong, non-specific oxidants. Advanced oxidation completely mineralizes the organics, removing the toxicity and liability for future contamination from the contaminant. Hydroxyl radicals are extremely short-lived, and must be generated as-needed from various process including, but not limited to, ozone, ozone/hydrogen peroxide, ultraviolet light/hydrogen peroxide, ultraviolet light/titania, and iron/hydrogen peroxide.

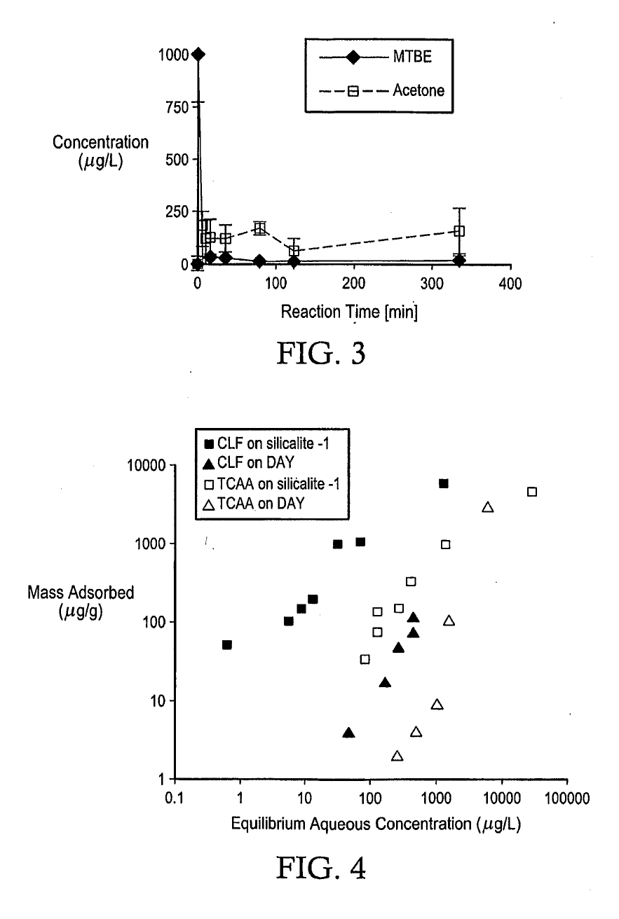

Advanced oxidation with nanoscale zerovalent iron and hydrogen peroxide rapidly and completely degraded MTBE in water, as shown in FIG. 3.

Chloroform (“CLF”) and trichloroacetic acid (“TCAA”) were adsorbed onto two zeolites, silicalite-1 and a dealuminated zeolite Y (DAY). The effect of humic acid on adsorption capacities was also tested. The zeolites were regenerated with zero valent iron and hydrogen peroxide (Fe⁰/H₂O₂) advanced oxidation. The zeolite was coated with zerovalent iron, immersed in aqueous solution, and dosed with H₂O₂ to initiate the formation of hydroxyl radicals that mineralized chloroform and trichloroacetic acid associated with the solid zeolites (heterogeneous advanced oxidation). This destroyed the contaminants, and effectively regenerated the sorbents.

The CLF and TCAA adsorption isotherms are shown in FIG. 4. In the concentration range of interest for drinking water (i.e., below ca. 1000 μg/L), CLF and TCAA adsorbed to a greater extent to silicalite-1 than to DAY. MTBE adsorbed to zeolites in the following order: silicalite-1 (adsorbed the greatest), mordenite, zeolite beta, DAY (adsorbed the least). The SiO₂/Al₂O₃ ratio and framework density were the primary predictors (statistically) for MTBE adsorption affinity on zeolites, with silicalite-1 having the greatest SiO₂/Al₂O₃ ratio (>1000) and framework density (18.4 T atoms/Å³). Similar trends in adsorption capacity for trichloroethylene (“TCE”) were observed.

For the same aqueous concentration, the equilibrium adsorbed concentration of CLF was approximately an order of magnitude greater than for TCAA due to molecular size exclusion, as the CL, molecule is smaller with a molecular weight of 119.39 versus 163.39 for TCAA. CLF also has much lower solubility than TCAA, 0.82 g/100 g (at 20° C.) versus 120 g/100 g for TCAA, which explains the greater affinity for zeolites than TCAA, since the hydrophobic zeolite pore system excludes water and provides an organophilic environment.

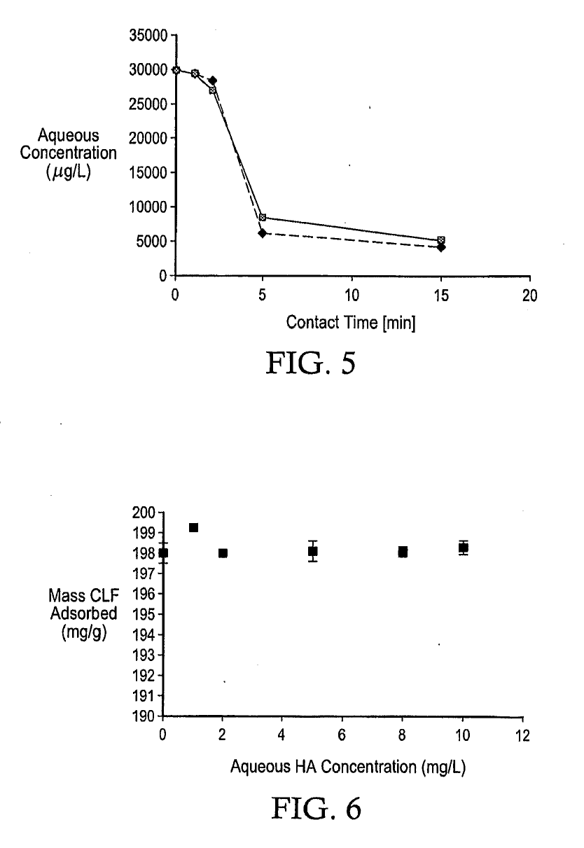

The adsorption of CLF took place rapidly as shown in FIG. 5. Experimental conditions: 0.2 g silicalite-1 in 40 mL aqueous solution. Starting with approximately 30,000 μg/L CLF initially in aqueous solution, the concentration of CLF in solution decreased to an equilibrium concentration of about 5,000 μg/L within approximately 15 minutes. All adsorption isotherm experiments assuming equilibrium were conducted for 24 h, so equilibrium was assured.

Humic materials, a product of the decay of organic matter, may be present in raw water utilized for drinking water purposes, and may cover the solid surfaces or block pores preventing adsorption of contaminants. However, adsorption of CLF to silicalite-1 in the presence of up to 10 mg/L humic acid indicated no inhibition of adsorption of the CLF as shown in FIG. 6. The conditions were: 0.2 g silicalite-1 in 40 mL aqueous solution initially containing 1 ppm CLF. The humic acid was attached to the external surfaces of the silicalite-1, as the humic acid molecules are effectively size-excluded from the internal pores. That is, the DBP contaminants adsorbed to surfaces in the internal pores, which remain free of humic acid.

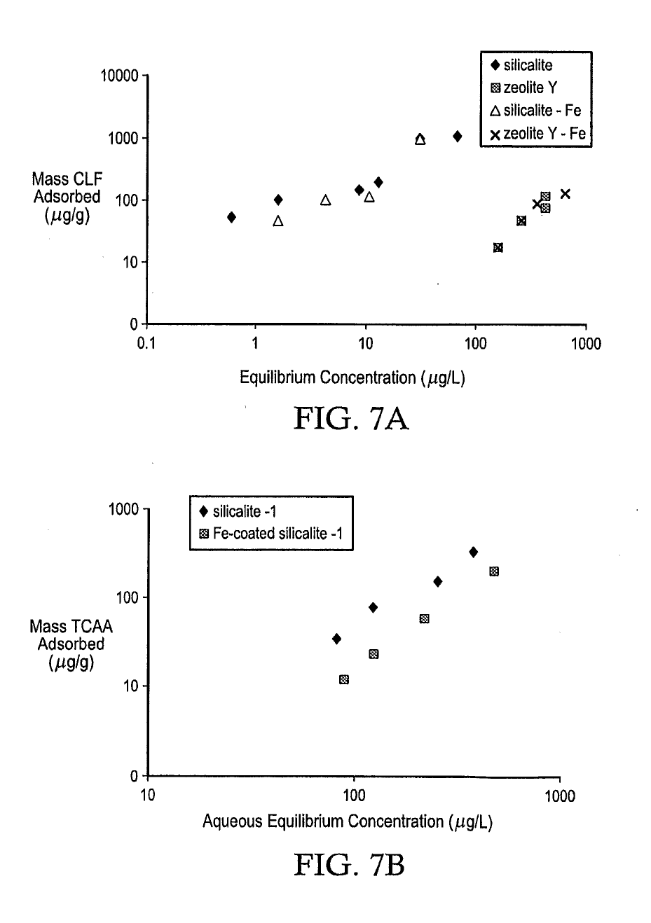

The silicalite-1 and DAY were coated with Fe⁰ through borohydride reduction. As shown in FIG. 7, the Fe⁰ coating (25% by weight) had little effect on adsorption of CLF on silicalite-1 and DAY. However, the adsorption of TCAA on silicalite-1 was decreased by approximately 50% with the Fe⁰ coating. Thus, most Fe resided on external surfaces of silicalite-1 crystals, while some Fe occupied some internal pore space in the larger pores of the DAY.

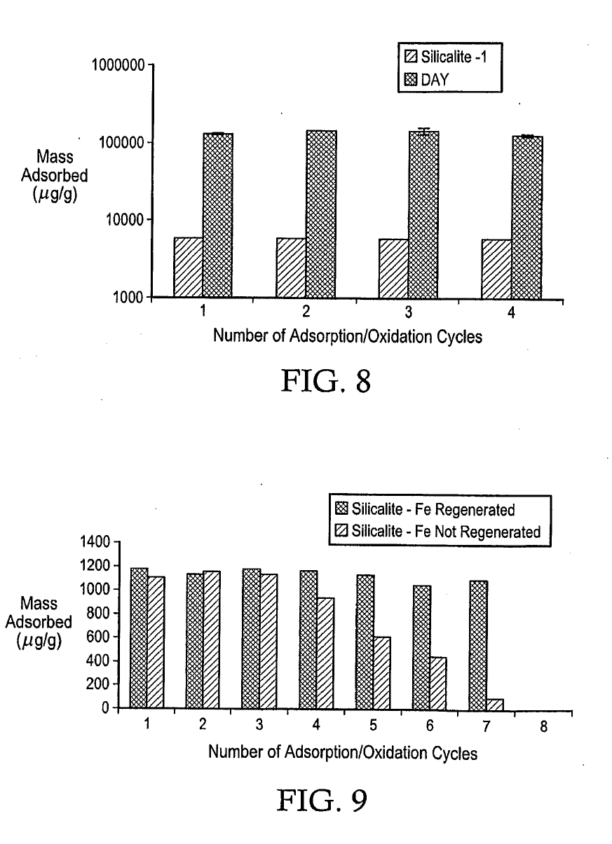

Repeated cycles of adsorption of CLF to silicalite-1 and DAY, followed by Fe⁰/H₂O₂ advanced oxidation reported in FIG. 8 showed that the capacity of the zeolites for CLEF remained constant for at least 4 cycles. Initial CLF concentration on silicalite-1=5700 μg/g, and on DAY=126,000 μg/g. Data are averages of duplicate experiments, with error bars indicating ranges. Initial CLF in aqueous solution was 30 mg/L for experiments with silicalite-1, and 1 g/L for experiments with DAY. The zeolites were regenerated with 30% H₂O₂ in between adsorption cycles. Therefore, hydrophobic molecular sieve zeolites can be used to concentrate organics in the micropore system, so that mineralization by advanced oxidation can be utilized in more confined volumes than in free aqueous systems.

Repeated adsorption of CLF to silicalite-1 resulted in saturation of the solid media, with no further uptake of CLF by the solid possible after 7 cycles, as FIG. 9 illustrates. Experimental conditions: 0.2 g Fe⁰-coated silicalite-1 in 40 mL aqueous solution initially containing 1 ppm CLF. Regenerated with 30 mL 30% H₂O₂ in between adsorption cycles. However, subjecting the Fe⁰-coated silicalite-1 to advanced oxidation through addition of H₂O₂ to the solution after each adsorption cycle, resulted in constant capacity for adsorption. Chloride production was followed for the adsorption/oxidation cycles, and is reported in Table 1, indicating almost complete liberation of chloride.

TABLE 1
Chloride ion production during adsorption and oxidation cycles.

| [H₂O₂]:[CLF] molar ratio | 50:1 | 100:1 | 1000:1 |
|---|---|---|---|
| Cl⁻ (% of stoichiometric) | 92-97% | 94-98% | 97-98% |

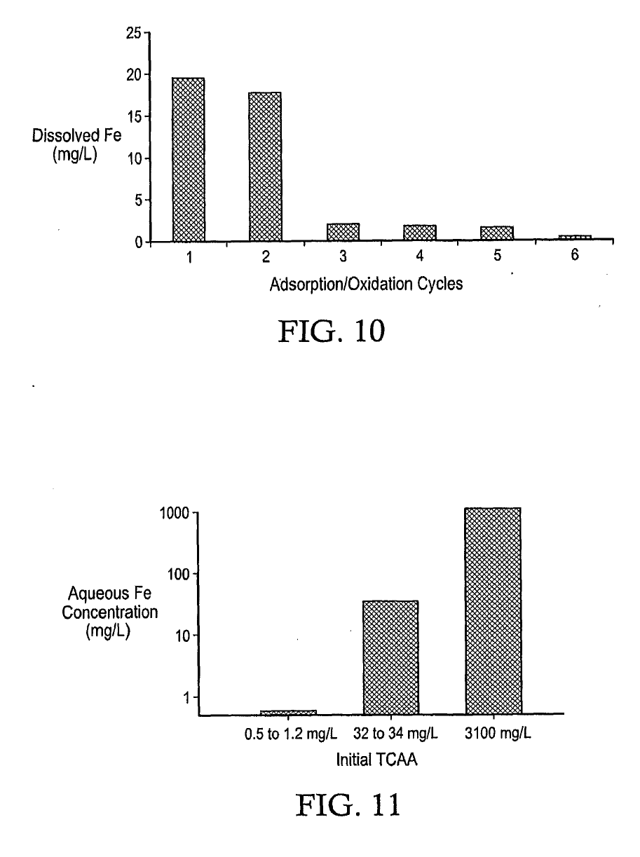

The number of cycles that the iron coating will last for successful regeneration may be limited due to removal of iron from the zeolites by dissolution. The dissolved Fe values in solution subsequent to the oxidation cycles were quantified via atomic absorption. The results are shown in FIG. 10 for CLF. Initial CLF concentration before adsorption was 3100 mg/L. The iron that was dissolved in aqueous solution after adsorption and oxidation steadily decreased with adsorption and oxidation cycles. However, it was found that the dissolved Fe was a function of TCAA concentration, as illustrated in FIG. 11.

### EXAMPLES

Silicalite-1 was obtained from Union Carbide (Houston, Tex.). The properties of the silicalite-1 were: pore volume=0.21 cm³/g, large dimensions of pores=5.5×5.6 Å, SiO₂/Al₂O₃ ratio>1000, and hydrophobicity (by TGA analysis)=0.92 (Erdem-Senatalar et al., 2004a) The dealuminated zeolite Y (DAY) was from Zeolyst (Kansas City, Kan.), and had pore volume 0.38 cm³/g, large dimensions of pores=7.4 Å, SiO₂/Al₂O₃ ratio 80, and hydrophobicity (by TGA analysis)=0.89. Chloroform (CLF) and trichloroacetic acid (TCAA) were purchased from HACH Company (ACS grade, Loveland, Colo.) and Sigma-Aldrich (St. Louis, Mo.), respectively. All water used was purified by a Barnstead ROPure ST/E-pure water system (Barnstead/Thermolyne, Dubuque, Iowa).

To obtain the isotherm data, the concentrations of the initial DBP solutions were varied with constant sorbent/liquid ratios (0.2 g sorbent in 40 mL solution). Adsorption was allowed to proceed for 24 hour contact times on an orbital shaker table at room temperature, which is sufficient for equilibrium. Solid-liquid separation was done by centrifugation for 10 min at 3000 rpm (Eppendorf 5804 centrifuge, Eppendorf, Germany).

All adsorbents were dried in an atmospheric oven at 120° C. for 10-14 h prior to use Prior to experiments, all zeolite samples were brought to moisture equilibrium in a saturated humidity atmosphere in a desiccator containing a supersaturated solution of CaCl₂ in water.

To analyze CLF in water, solid phase microextraction (“SPME”) was used. The CLF was extracted and concentrated by SPME using Carboxen™/PDMS fibers (Supelco, Inc., Belleforte, Pa.) with 85-μm film thickness and then analyzed by gas chromatography (“GC”). The samples were diluted when necessary for analysis. The GC (Series 6890, Agilent Technologies, Palo Alto, Calif.) was equipped with a flame ionization detector (“FID”), and a J&W Scientific DB-624 capillary column 30 m in length and 317 μm in nominal diameter. The inlet and detector temperatures were 220° C. and 250° C., respectively. The CC oven program was as follows: 35° C. for 4 min, ramped to 90° C. at 20° C./min, held for 3 min, finally ramped, to 200° C. at 40° C./min and held for 10 min.

The TCAA was extracted and concentrated with headspace solid phase microextraction (“HS-SPME”) using Carboxen™/PDMS fibers (Supelco, Inc., Belleforte, Pa.) with 85 μm film thickness. Prior to extraction with HS-SPME, in situ derivatization of the TCAA to methyl trichloroacetate was conducted by addition of 5 g of anhydrous sodium sulfate to 10 mL of sample in 40 mL glass vials while continuously mixing with a Teflon coated stir bar, addition of 20 μl tetrabutylammonium hydrogen sulfate (TBA-HSO4) (>99%, Fluka), followed by the addition of 50 μl dimethyl sulfate (>99%, Fluka). The vial was capped and placed in a water-thermostabilized bath at 57° C. for 5 min. After derivatization, HS-SPME was conducted, followed by analysis with the GC equipped with an electron capture detector (“ECD”). The column was a J&W Scientific (Agilent Technologies) DB-5 column that was 30 m in length, 251 μm i.d., and 25 μm film thickness. The carrier gas and makeup gas (20 mL/min) to the ECD was nitrogen. The GC oven program was as follows: 40° C. for 4 min, ramped to 72° C. at 8° C./min, and then ramped to 250° C. at 40° C./min.

To determine the influence of humic acid (ICN Biomedical Inc.) on CLF adsorption, silicalite-1 (0.2 g) was added to 40 mL purified water containing 1 ppm CLF and humic acid ranging in concentration from 1 to 10 ppm.

Silicalite-1 and DAY successfully removed the two DBPs studied from water (FIGS. 1 through 4), yet the contaminants remained in the sorbents in concentrated form after adsorption. Silicalite-1 adsorbed more CLF and TCAA than the DAY sample at these low concentrations. CLF adsorbed better than TCAA in both zeolite samples due to its smaller molecular size and much lower aqueous solubility.

To regenerate the DBP-saturated silicalite by Fe⁰/H₂O₂ advanced oxidation, the silicalite was coated with zero-valent iron (Fe⁰) with a borohydride reduction procedure. In this procedure, Fe was coated on the zeolite surfaces through reaction of ferrous iron (FeSO₄.7H₂O, ACS Grade, Fisher Scientific, Pittsburgh, Pa.) with sodium borohydride (NaBH₄, ACS Grade, Fisher Scientific, Pittsburgh, Pa.). The Fe coating on the adsorbent was 25% by weight with this procedure, which was used to determine the influence of the Fe⁰ coating on the adsorption properties of the silicalite. To initiate advanced oxidation, the Fe⁰ coated adsorbent was subjected to 30% H₂O₂ (ACS Grade, Fisher Scientific, Pittsburgh, Pa.) solution (in water). The adsorbent was subjected to repeated cycles of adsorption followed by regeneration. The concentration of DBPs in aqueous solution after each cycle was measured, and oxidation was followed by measuring chloride ion concentration in solution using a chloride ion probe (Accumet chloride combination ion selective electrode, Fisher Scientific). Iron concentration in the solution was measured using atomic absorption spectrometry (Perkin Elmer Analyst 300, Wellesley, Mass.).

Although the invention has been described with respect to various embodiments, it should be realized this invention is also capable of a wide variety of further and other embodiments within the spirit and scope of the present invention as defined by the appended claims.

What is claimed is:

1. A method for removing organic contaminants from water, comprising
(i) contacting said water with an adsorbent under suitable conditions allowing said organic contaminants to adsorb to said adsorbent,
(ii) separating said adsorbent from said water, and
(iii) reacting said adsorbed organic contaminants with an oxidation reagent.

2. The method of claim 1, wherein said adsorbent is a hydrophobic molecular sieve.

3. The method of claim 2, wherein said molecular sieve has pore sizes ranging from about 3 to about 10 angstroms.

4. The method of claim 2, wherein said hydrophobic molecular sieve is one or more zeolites.

5. The method of claim 4, wherein said one or more zeolites are selected from the group consisting of silicalite-1, dealuminated zeolite Y, ZSM-5, mordenite, and zeolite beta.

6. The method of claim 5, wherein said silicalite-1 has a pore diameter ranging from about 5.1 to about 5.6 angstroms.

7. The method of claim 5, wherein said dealuminated zeolite Y has a pore diameter around 7.4 angstroms.

8. The method of claim 2, wherein said hydrophobic molecular sieve is Mobil Composition Matter or activated carbon material.

9. The method of claim 1, wherein said oxidation reagent is selected from the group consisting of ozone, ozone/hydrogen peroxide, ferrous iron/hydrogen peroxide, zerovalent iron/hydrogen peroxide, and a like.

10. The method of claim 1, wherein said oxidation reagent is used to produce hydroxyl radicals.

11. The method of claim 10, wherein said hydroxyl radicals are generated by an electrochemical process, exposure to ultraviolet light/hydrogen peroxide or ultraviolet light/titania.

12. The method of claim 1, wherein said organic contaminants are selected from the group consisting of trichloroethylene, methyl-tert-butyl ether, BTEX (benzene, toluene, ethylbenzene, and xylenes), alcohols, trihalomethanes, haloacids, halodiacids, halohydroxy-acids, and haloketones.

13. The method of claim 12, wherein said trihalomethane is selected from the group consisting of chloroform, bromodichloromethane, and chlorodibromomethane.

14. The method of claim 12, wherein said haloacid is selected from the group consisting of monochloroacetic acid, dichloroacetic acid, and trichloroacetic acid.

15. The method of claim 12, wherein said halodiacid is selected from the group consisting of 2,2-dichlorobutanedioic acid and 2,3-dichlorobutanedioic acid.

16. The method of claim 12, wherein said halohydroxy-acid is selected from the group consisting of 2-chloro-4-hydroxybutanoic acid and 3,3,3-trichloro-2-hydroxypropanoic.

17. The method of claim 12, wherein said haloketone is selected from the group consisting of chloropropanone and 1,1,1-trichloropropanone.

18. The method of claim 1, wherein said adsorbent is affixed to a substrate.

19. The method of claim 18, wherein said substrate is a permeable membrane.

20. The method of claim 19, wherein said permeable membrane is a polycrystalline particulate aggregate.

21. The method of claim 1, wherein said adsorbent is contacted by said water in a batch process.

22. The method of claim 1, wherein said separating said adsorbent from said water is accomplished via centrifugation or filtration.

23. A method for removing organic contaminants from water, comprising
(i) contacting said water with one or more zeolites under suitable conditional allowing said organic contaminants to adsorb to said one or more zeolites,
(ii) separating said adsorbent from said water, and
(iii) reacting said adsorbed organic contaminants with an oxidation reagent.
